(19) United States
(12) Patent Application Publication
(10) Pub. No.: US 2016/0374017 A1
(43) Pub. Date: Dec. 22, 2016

(54) Systems and methods for determining device-specific signal extension durations

(71) Applicant: Intel IP Corporation, Santa Clara, CA (US)

(72) Inventors: Robert Stacey, Portland, OR (US); Qinghua Li, San Ramon, CA (US); Assaf Gurevitz, Ramat Hasharon (IL); Ran Shimon, Ramat Gan (IL); Chen Kojokaro, Yoqneam Illit (IL)

(21) Appl. No.: 14/757,828

(22) Filed: Dec. 26, 2015

Related U.S. Application Data
(60) Provisional application No. 62/181,527, filed on Jun. 18, 2015.

(51) Int. Cl. H04W 52/02; H04L 5/00

(52) U.S. Cl. CPC H04W 52/0216; H04L 5/0007; H04W 84/12

(57) ABSTRACT

Systems, apparatus, and methods for determining device-specific signal extension durations are disclosed. An example method includes determining a short interframe space (SIFS) time associated with the at least one processor; determining that a first processing time of the at least one processor exceeds a first predefined threshold, wherein the first processing time correspond to a time spent processing a symbol in a protocol data unit (PDU) exceeding a predetermined coded bit size threshold; determining that a second processing time of the at least one processor exceeds a second predetermined threshold, based at least in part on the first processing time; and determining that the second processing time exceeds the SIFS time.

### CROSS REFERENCE TO RELATED APPLICATION

This application claims the benefit of U.S. Patent Application No. 62/181,527 filed on Jun. 18, 2015, the disclosure of which is incorporate herein by reference as set forth in full.

### TECHNICAL FIELD

This disclosure generally relates to systems and methods for Wi-Fi, and more particularly to determining signal extension durations for Wi-Fi communication.

### BACKGROUND

Wireless devices are becoming widely prevalent and users of such devices are increasingly requesting access to wireless channels high speed and reliability. Next generation wireless technologies and standards are under development meet such demands. One such next generation wireless local area network (WLAN), IEEE 802.11ax or High-Efficiency WLAN (HEW), is under development. HEW utilizes Orthogonal Frequency-Division Multiple Access (OFDMA) in channel allocation.

### BRIEF DESCRIPTION OF THE FIGURES

Reference will now be made to the accompanying drawings, which are not necessarily drawn to scale, and wherein:

FIG. 1 depicts a simplified schematic diagram of an example environment with a wireless local area network (WLAN) with an access point (AP) and one or more user devices, in accordance with example embodiments of the disclosure.

FIG. 2 depicts a simplified block diagram illustrating an example architecture of the AP of the example WLAN of FIG. 1, in accordance with example embodiments of the disclosure.

FIG. 3 depicts a simplified block diagram illustrating an example architecture of a user device (STA) of the environment of FIG. 1, in accordance with example embodiments of the disclosure.

FIG. 4 depicts a datagram illustrating an example preamble of a physical layer convergence protocol (PLCP) protocol data unit (PPDU) used for allocating frequency resource units (RU) by the AP to the STA, in accordance with example embodiments of the disclosure.

FIG. 5 depicts a datagram illustrating example pre-FEC, post-FEC padding, and signal extension, in accordance with example embodiments of the disclosure.

FIG. 6 depicts a datagram illustrating example FEC payload thresholds, in accordance with example embodiments of the disclosure.

FIG. 7 depicts a datagram illustrating example service field bit assignment, in accordance with example embodiments of the disclosure.

FIG. 8 depicts a datagram illustrating example VHT-SIG-B and service field relationship, in accordance with example embodiments of the disclosure.

FIG. 9 depicts a datagram illustrating an example signal extension indication in single user mode, in accordance with example embodiments of the disclosure.

FIG. 10 depicts a datagram illustrating an example signal extension indication in multi user mode, in accordance with example embodiments of the disclosure.

FIG. 11 depicts a datagram illustrating an example service field and signal extension bits, in accordance with example embodiments of the disclosure.

FIG. 12 depicts a datagram illustrating an example reuse of legacy length field, in accordance with example embodiments of the disclosure.

FIG. 13 depicts an illustrative process flow for determining the processing time of a packet, according to one or more example embodiments of the disclosure.

FIG. 14 depicts an illustrative process flow for determining the processing time of a packet, according to one or more example embodiments of the disclosure.

FIG. 15 depicts an illustrative process flow for transmitting a downlink frame with a signal extension, according to one or more example embodiments of the disclosure.

### DETAILED DESCRIPTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the disclosure to those skilled in the art. Like numbers refer to like, but not necessarily the same or identical, elements throughout.

Embodiments of the disclosure may provide systems, apparatus, and methods for determining device-specific signal extension durations, for example in a wireless local area network (WLAN), such as a high efficiency wireless local area network (HEW) that may operate according to any variety of standards. In example embodiments, the systems, apparatus, and methods, as described herein, may operate in accordance with Institute of Electrical and Electronics Engineers (IEEE) 802.11ax standards or modifications thereto.

In accordance with example embodiments, a Wi-Fi access point (AP) may be configured to identify a number of user devices or stations (STA) with which it is to facilitate wireless communications. The STAs may be identified by any variety of handshaking procedures, such as procedures involving the broadcast of beacons from the AP and/or a request for connection by the STAs, etc. The AP may allocate a station identification (STAID) to each of the STAs during the handshaking procedure. The AP may then allocate frequency and/or temporal resources to the STAs with which it is to communicate. The AP may provide an indication of a frequency resource unit (RU) to each of the STAs with which the AP is to communicate and provide WLAN services.

The RUs, in example embodiments, may be a collection of tones within a channel (e.g., partitions of the total bandwidth of the channel). As a non-limiting example, a 20 MHz channel may be divided into 256 tones, 242 of which may be used for data transmission and/or reception. As another non-limiting example, a 40 MHz channel may be divided into 512 tones, 484 of which may be used for data transmission and/or reception. As yet another non-limiting example, a 80 MHz channel may be divided into 1024 tones, 968 of which may be used for data transmission and/or reception. It will be appreciated that there may be any suitable channel bandwidth and number of tones in accordance with example embodiments of the disclosure and that the disclosure is not limited to the examples discussed herein. A RU may have any variety of size in the frequency domain. For example a minimum sized RU may include 26 tones. Other RUs may have 52 tones, 106 tones, 242 tones, 484 tones, or the like.

In example embodiments, the AP may generate a physical layer convergence protocol (PCPL) protocol data unit (PPDU) that includes a payload section and a high efficiency wireless (HEW) preamble section. The preamble section may include a number of portions. In example embodiments, there may be a legacy preamble portion (L-SIG) that may enable the PPDU to be backward compatible for communications with STAs that may be operating using standards prior to IEEE 802.11ax. The HEW preamble may further include a HE-SIG-A portion and a HE-SIG-B portion. The HE-SIG-A portion may provide information that enables the decoding of the HE-SIG-B section by the STAs that receive the PPDU. This information may include, for example, modulation and coding scheme (MSC) of the HE-SIG-B, the length of HE-SIG-B, and/or the guard interval (GI) length of HE-SIG-B. The HE-SIG-A may also provide timing information related to the duration of the current RU allocations for each of the STAs.

The HE-SIG-B, in some example embodiments, may only have a STA specific part. In these example embodiments, the STA specific part may include a portion carrying information for each of the STAs with which the AP is to communicate and provide a corresponding RU allocation. The information for each of the STA may include the STAID of the STA to indicate to the STA to listen, a RU allocation index that indicates the RU allocation for that STA, a MSC index to indicate the modulation and coding scheme (MSC) for that STA, and a CRC. In accordance with example embodiments of the disclosure, there may be fewer or additional data items that may be communicated to each of the STAs via the STA specific part of the HE-SIG-B. The RU allocation index may, in example embodiments, indicate a particular RU allocation in a fixed RU pattern. For example, a 20 MHz channel may be divided into 16 possible RU allocation blocks and set as a RU pattern for that 20 MHz channel. In this case, the 16 different RU allocation blocks may be indexed (e.g., such as by using 4 bits). Therefore, with a 20 MHz channel, in example embodiments, a 4 bit RU allocation index may be communicated to each STA within the STA specific part of the HE-SIG-B to indicate a corresponding RU allocation for each of the STAs. The STAs may be preprogrammed with the mapping of the RU allocation index to particular RUs, such that the STA may determine its RU allocation as assigned by the AP. The 4 bit RU allocation index of the 20 MHz channel may be shorter for each of the STAs than conveying this information using a bitmap (e.g., 9 bit bitmap). It will be appreciated that in a 40 MHz channel with a minimum RU size of 26 tones, a 5 bit RU allocation index may be used. Furthermore, in a 80 MHz channel with a minimum RU size of 26 tones, a 7 bit RU allocation index may be used. It is seen, therefore, that by having a fixed RU pattern, each of the potential RU allocations may be indexed and communicated relatively more efficiently to the STAs than if a bitmap was transmitted to each of the STAs.

In other example embodiments, the HE-SIG-B may include both a common part and a STA specific part. The common part may be used by all of the STAs with which the AP is to provide an RU allocation. This common part may include a RU pattern index, that references a particular RU pattern or mapping of RU within a channel. Once the STAs identify the RU pattern from the common part, the STAs will know the RU allocation indexes associated with that RU pattern. In this case, the AP, in the STA specific part of the HE-SIG-B, may indicate, for each STA (e.g., as referenced by each STA's STAID) the RU allocation index referenced to the RU pattern index, as indicated in the common part of the HE-SIG-B. In this way, a fewer number of bits may be communicated to each of the STAs within the STA specific part of the HE-SIG-B. Accordingly, a fewer number of bits may be used for the purposes of the RU allocation to the STAs in the PPDU. The RU allocation index associated with the RU pattern may not be needed if the STA specific parts are sequentially arranged in the same order as their corresponding RUs located in the RU allocation pattern.

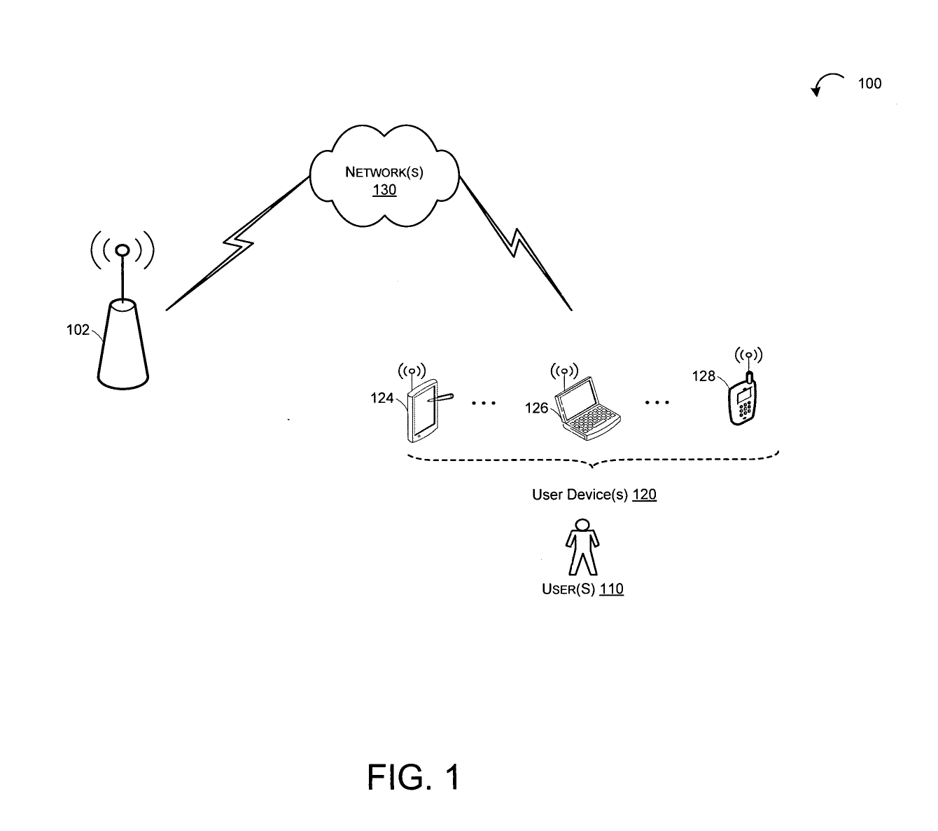

FIG. 1 depicts a simplified schematic diagram of an example environment with a wireless local area network (WLAN) with an access point (AP) and one or more user devices, in accordance with example embodiments of the disclosure. Network environment 100 can include one or more computing devices 120 and one or more access point(s) (AP) 102, which may communicate in accordance with IEEE 802.11 communication standards, including IEEE 802.11ax. The computing device(s), user device(s), or stations 124, 126, 128 (hereinafter referred to individually or collectively as STA 120 or STAs 120, respectively) may be mobile devices that are non-stationary and do not have fixed locations. The one or more APs 102 may be stationary and have fixed locations, in some example embodiments. In other example embodiments, the AP may also be mobile.

In accordance with some IEEE 802.11ax (High-Efficiency WLAN (HEW)) embodiments, the AP 102 may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, in some example embodiments, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

One or more illustrative user device(s) 120 may be operable by one or more users 110. The user device(s) 120 may include any suitable processor-driven user device including, but not limited to, a desktop computing device, a set-top box (STB), a game console, a laptop computing device, a server, a router, a notebook computer, a netbook computer, a web-enabled television, a switch, a smartphone, a tablet, wearable wireless device (e.g., bracelet, watch, glasses, ring, etc.), combinations thereof, or the like.

Any of the STA(s) 120 (e.g., user devices 124, 126, 128), and AP 102 may be configured to communicate with each other via one or more communications networks 130 wirelessly. Indeed the communications network (e.g., WLAN 130) may be established and used according to the systems, apparatus, and methods, as described herein. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, WLAN 130 may configured to connect to any type of medium over which network traffic may be carried via the AP 102 including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the STA(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the STAs 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad), or 802.11ax channels. In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

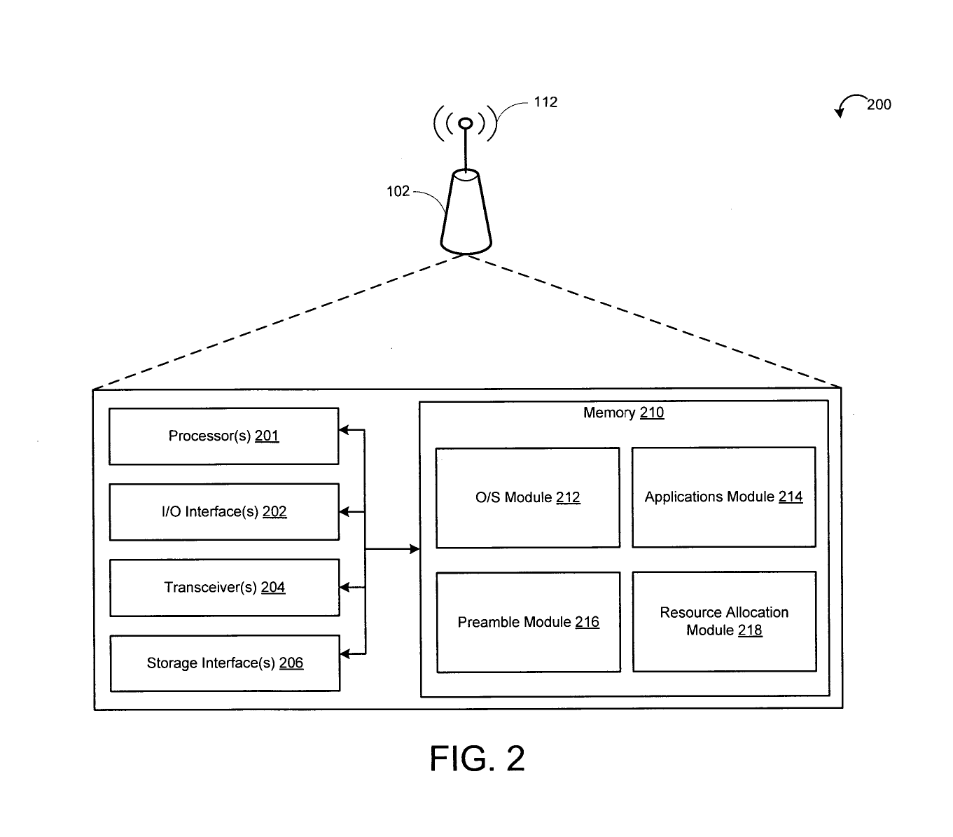

FIG. 2 depicts a simplified block diagram illustrating an example architecture of the AP 102 of the example WLAN of FIG. 1, in accordance with example embodiments of the disclosure. The AP 102 may include one or more antennas 112. The AP 102 may further include one or more processor(s) 201, one or more I/O interface(s) 202, one or more transceiver(s) 204, one or more storage interface(s) 206, and one or more memory or storage 210.

The communications antenna 112 may be any suitable type of antenna corresponding to the communications protocols used by the AP 102. Some non-limiting examples of suitable communications antennas 112 include Wi-Fi antennas, IEEE 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to the transceiver 204 to transmit and/or receive signals, such as communications signals to and/or from STAs 120.

The processors 201 of the AP 102 may be implemented as appropriate in hardware, software, firmware, or combinations thereof. Software or firmware implementations of the processors 201 may include computer-executable or machine-executable instructions written in any suitable programming language to perform the various functions described. Hardware implementations of the processors 201 may be configured to execute computer-executable or machine-executable instructions to perform the various functions described. The one or more processors 201 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The AP 102 may also include a chipset (not shown) for controlling communications between one or more processors 201 and one or more of the other components of the AP 102. The processors 201 may also include one or more application specific integrated circuits (ASICs) or application specific standard products (ASSPs) for handling specific data processing functions or tasks. In certain embodiments, the AP 102 may be based on an Intel® Architecture system and the one or more processors 201 and chipset may be from a family of Intel® processors and chipsets, such as the Intel® Atom® processor family.

The one or more I/O interfaces 202 may enable the use of one or more (I/O) device(s) or user interface(s), such as a keyboard and/or mouse. The storage interface(s) 206 may enable the AP 102 to store information, such as status and/or location information or deployment information in storage devices and/or memory 210.

The transmit/receive or radio component 204 may include any suitable radio for transmitting and/or receiving radio frequency (RF) signals in the bandwidth and/or channels corresponding to the communications protocols utilized by the AP 102 to communicate with STAs 120 or other APs 102. The transceiver 204 may include hardware and/or software to modulate communications signals according to pre-established transmission protocols. The transceiver 204 may further have hardware and/or software instructions to communicate via one or more Wi-Fi and/or Wi-Fi direct protocols, as standardized by the Institute of Electrical and Electronics Engineers (IEEE) 802.11 standards. In certain embodiments, the transceiver 204, in cooperation with the communications antennas 112, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad), or 802.11ax standards. In alternative embodiments, non-Wi-Fi protocols may be used for communications between adjacent AP 102, such as Bluetooth, dedicated short-range communication (DSRC), or other packetized radio communications. The transceiver 204 may include any known receiver and baseband suitable for communicating via the communications protocols of AP 102. The radio component may further include a low noise amplifier (LNA), additional signal amplifiers, an analog-to-digital (A/D) converter, one or more buffers, and digital baseband.

The memory 210 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 210 may store program instructions that are loadable and executable on the processor(s) 201, as well as data generated or received during the execution of these programs. Turning to the contents of the memory 210 in more detail, the memory 210 may include one or more operating systems (O/S) 212, an applications module 214, a preamble module 216, and a resource allocation module 218. Each of the modules and/or software may provide functionality for the AP 102, when executed by the processors 201. The modules and/or the software may or may not correspond to physical locations and/or addresses in memory 210. In other words, the contents of each of the modules 212, 214, 216, 218 may not be segregated from each other and may, in fact be stored in at least partially interleaved positions on the memory 210.

The O/S module 212 may have one or more operating systems stored thereon. The processors 201 may be configured to access and execute one or more operating systems stored in the (O/S) module 212 to operate the system functions of the electronic device. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

The application(s) module 214 may contain instructions and/or applications thereon that may be executed by the processors 201 to provide one or more functionality associated with the resource unit (RU) allocation to each of the STAs 120 and communications with the STAs 120. These instructions and/or applications may, in certain aspects, interact with the (O/S) module 212 and/or other modules of the AP 102. The applications module 214 may have instructions, software, and/or code stored thereon that may be launched and/or executed by the processors 201 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof.

The preamble module 216 may have instructions stored thereon that, when executed by the processors 201, enable the AP 102 to provide a variety of preamble generation of the PPDU and communications functionality. In one aspect, the processors 201 may be configured to generate a legacy portion of the HEW preamble (L-SIG), HE-SIG-A, and HE-SIG-B. The HE-SIG-B, additionally may carry a RU allocation index corresponding to each of the STAs to which an RU allocation is to be made that may be a fixed index or an index referenced to a RU pattern. This RU allocation index may indicate the RU that is being assigned to each of the STAs.

The resource allocation module 218 may have instructions stored thereon that, when executed by the processor(s) 201, enable the AP 102 to provide a variety of RU allocation functionality. The processor(s) 201 may be configured to identify a RU allocation for each of the STAs 120 based on priority and/or expected data traffic associated with each of the STAs 120. The processor(s) 201 may further be configured to determine if the HE-SIG-B is to have a common part or only a STA specific part. When the HE-SIG-B is to provide an indication of a RU pattern and a RU allocation referenced to that RU pattern, then the HE-SIG-B may have both a common part and a STA specific part. The RU pattern may be indicated, such as by an RU pattern index, in the common part and the RU allocation index referenced to the RU pattern in the STA specific part.

It will be appreciated that there may be overlap in the functionality of the instructions stored in the operating systems (O/S) module 212, the applications module 214, the preamble module 216, and/or the resource allocation module 218. In fact, the functions of the aforementioned modules 212, 214, 216, 218 may interact and cooperate seamlessly under the framework of the AP 102. Indeed, each of the functions described for any of the modules 212, 214, 216, 218 may be stored in any module 212, 214, 216, 218 in accordance with certain embodiments of the disclosure. Further, in certain embodiments, there may be one single module that includes the instructions, programs, and/or applications described within the operating systems (O/S) module 212, the applications module 214, the preamble module 216, and/or the resource allocation module 218.

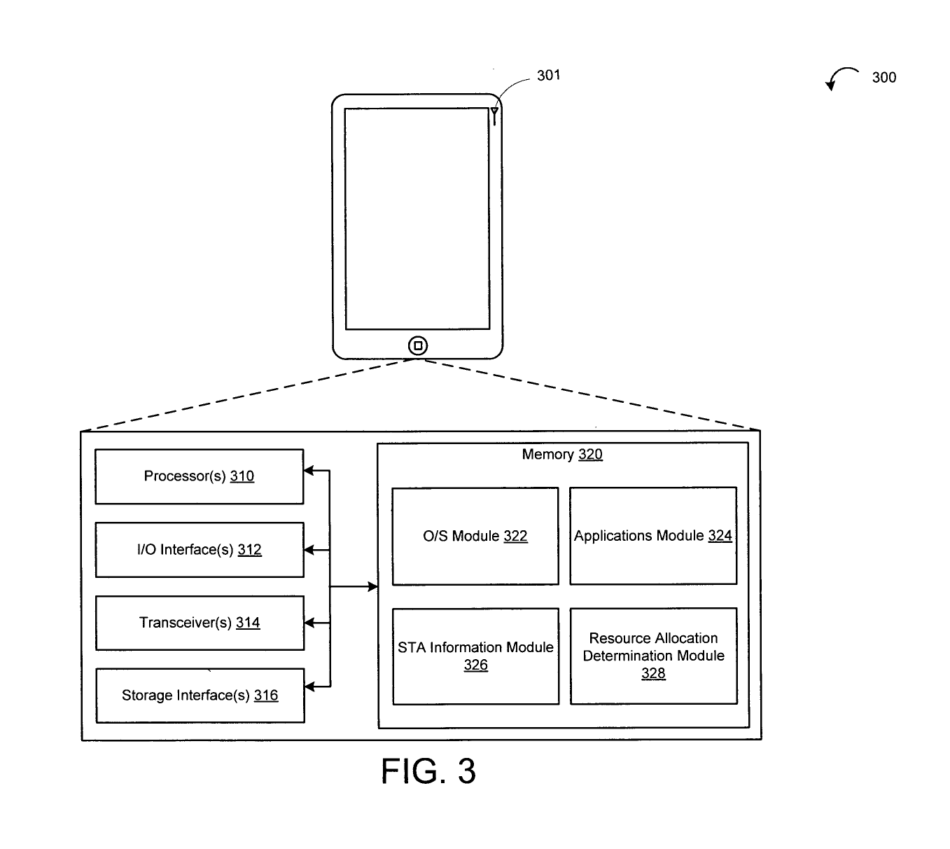

FIG. 3 depicts a simplified block diagram illustrating an example architecture of a user device (STA) 120 of the environment 100 of FIG. 1, in accordance with example embodiments of the disclosure. The STA 120 may include one or more antennas 300. The STA 120 may further include one or more processor(s) 310, one or more I/O interface(s) 312, one or more transceiver(s) 314, one or more storage interface(s) 316, and one or more memory or storage 320. The descriptions of the one or more antennas 300, the one or more processor(s) 310, one or more I/O interface(s) 312, one or more transceiver(s) 314, one or more storage interface(s) 316, and one or more memory or storage 320 of the STA 120 of FIG. 3 may be substantially similar to the descriptions of the one or more antennas 1120, the one or more processor(s) 201, one or more I/O interface(s) 202, one or more transceiver(s) 204, one or more storage interface(s) 206, and one or more memory or storage 210, respectively of the AP 102 of FIG. 2, and in the interest of brevity, will not be repeated here.

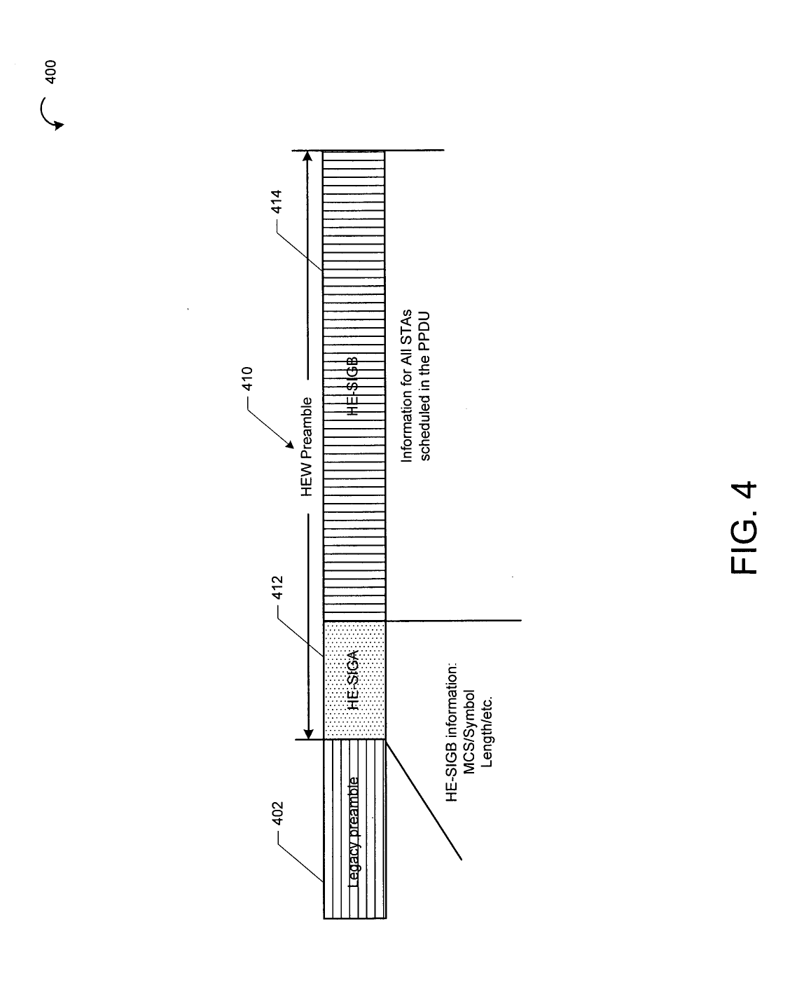

The memory 320 may store program instructions that are loadable and executable on the processor(s) 310, as well as data generated or received during the execution of these programs. Turning to the contents of the memory 320 in more detail, the memory 320 may include one or more operating systems (O/S) 322, an applications module 324, a STA information module 326, and a resource allocation determination module 328. Each of the modules and/or software may provide functionality for the STA 120, when executed by the processors 310. The modules and/or the software may or may not correspond to physical locations and/or addresses in memory 320. In other words, the contents of each of the modules 322, 324, 326, 328 may not be segregated from each other and may, in fact be stored in at least partially interleaved positions on the memory 320. The descriptions of the O/S module 322 and the application(s) module 314 of the STA 120 of FIG. 3 may be substantially similar to the descriptions of the O/S module 212 and the application(s) module 214 of the AP 102 of FIG. 4 and in the interest of brevity, will not be repeated here.

The STA information module 326 may have instructions stored thereon that, when executed by the processor(s) 310, enable the STA 120 to provide a variety of Wi-Fi communications functionality. The processor(s) 310 may be configured to receive a PPDU and identify the preamble therefrom. The processor(s) 310 may further be configured to identify a first part of the HEW preamble (e.g., HE-SIG-A) to decode a second part of the preamble (e.g., HE-SIG-B). The processor(s) 310 may still further be configured to use the information carried in the HE-SIG-A to decode the HE-SIG-B.

The resource allocation determination module 328 may have instructions stored thereon that may be executed by the processors 310 to receive and analyze PPDUs from the AP module 102 to identify a RU allocation. Once the HE-SIG-B is decoded, such as by the processes enabled by the STA information module 326, the processor(s) 310 may be configured to determine if the HE-SIG-B has a common part or only a STA specific part. If there is a common part, the processor(s) 310 may be configured to identify a RU pattern index from the common part. The processor(s) 310 may further be configured to access a mapping, such as a look-up table stored in memory 320, that maps the RU pattern to a grouping of RU allocation indices corresponding to particular RU blocks (e.g., defining the frequency range of the RU). At this point the RU allocation index allocated to the STA 120 may be determined from the STA specific part of the HE-SIG-B. In this case, the STA 120 may look for its PAID within the STA specific part of the HE-SIG-B to determine its corresponding RU allocation index, as referenced to the RU pattern indicated by the RU pattern index in the common part of the HE-SIG-B. In other example embodiments, the processor(s) 310, by executing the instructions stored in the resource allocation determination module 328, may identify that the HE-SIG-B includes only a STA specific part. In this case, the processor(s) 310 may be configured to determine the channel bandwidth (e.g., 20 MHz, 40 MHz, 80 MHz, etc.) and identify a predetermined RU map associated with the channel bandwidth. The STA specific part will carry a RU allocation index that may be mapped to various RU blocks according to the predetermined RU map that corresponds to the channel bandwidth. By knowing the RU allocation index, the STA 120 may know the RU parameters (e.g., frequency start or center point and range).

It will be appreciated that there may be overlap in the functionality of the instructions stored in the operating systems (O/S) module 322, the applications module 324, the STA information module 326, and the resource allocation module 328. In fact, the functions of the aforementioned modules 322, 324, 326, 328 may interact and cooperate seamlessly under the framework of the STAs 120. Indeed, each of the functions described for any of the modules 322, 324, 326, 328 may be stored in any module 322, 324, 326, 328 in accordance with certain embodiments of the disclosure. Further, in certain embodiments, there may be one single module that includes the instructions, programs, and/or applications described within the operating systems (O/S) module 322, the applications module 324, the STA information module 326, and the resource allocation module 328.

FIG. 4 depicts a datagram illustrating an example preamble 400 of a physical layer convergence protocol (PLCP) protocol data unit (PPDU) used for allocating frequency resource units (RU) by the AP 102 to the STA 120, in accordance with example embodiments of the disclosure. HE-SIG 410 field may have two parts: HE-SIG-A 412 and HE-SIG-B 414. HE-SIG-A 412 may include common information shared by all of the scheduled STAs 120 and nearby unscheduled STAs 120. HE-SIG-B 414 may include information for scheduled STAs 120. HE-SIG-A 412 may include the information needed for decoding HE-SIG-B 414, e.g. MCS of HE-SIG-B 414, length of HE-SIG-B 414, and/or guard interval (GI) length of HE-SIG-B 414. The HE-SIG-B 414 may include information needed for decoding the data of all scheduled STAs 120. The preamble 400 may also include a legacy preamble portion (L-SIG) 402 to enable backward compatibility.

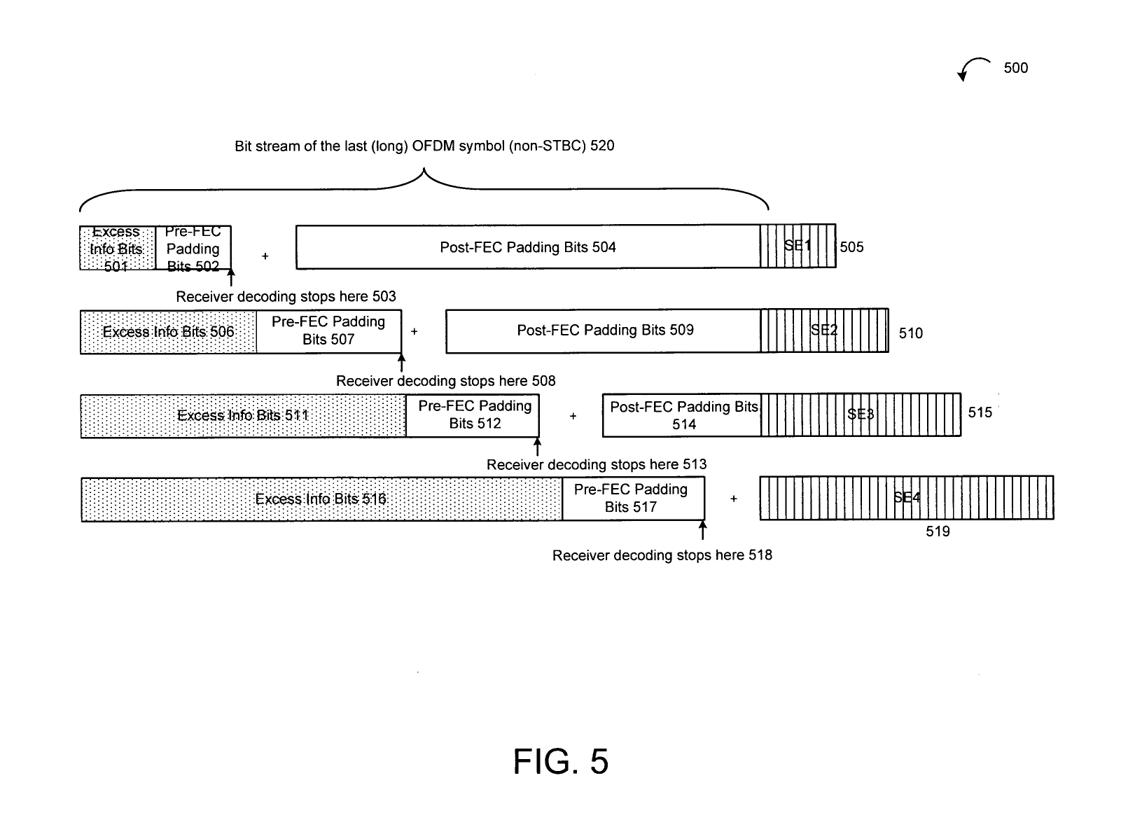

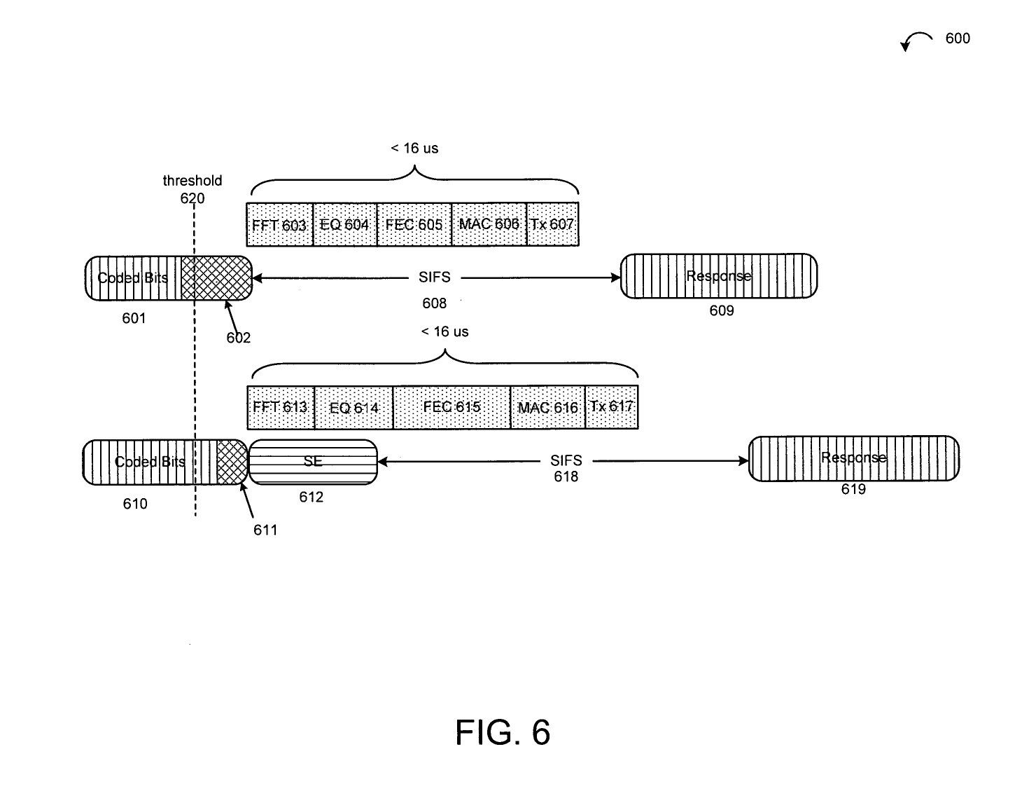

Referring to FIGS. 5 and 6, a set of signal extensions (SE) is illustrated in FIG. 5. Signal extension may be also referred to as packet extension in wireless standards such as 802.11ax. The signal extension may be added to the last long Orthogonal Frequency Division Multiplexing (OFDM) symbol that is not a Space Time Block Code (STBC). The last long OFDM may a bit stream (e.g., Bit stream of the last (long) OFDM symbol (non-STBC) 520). Specifically, FIG. 5 illustrates a 4 microsecond signal extension (SE1) (e.g., SE1 505), 8 microsecond signal extension (SE2) (e.g., SE2 510), 12 microsecond signal extension (SE3) (e.g., SE3 515), and 16 mircrosecond signal extension (SE4) (e.g., SE4 519). The signal extension may comprise an additional dummy signal after a field comprised of post-FEC padding bits (e.g., Post-FEC Padding Bits 504, Post-FEC Padding Bits 509, and Post-FEC Padding Bits 514) such that the receiver has additional time to decode the frame before sending an acknowledgement (ACK). For example, in IEEE 802.11ax systems, the tone number may be about four times greater than legacy IEEE 802.11n/ac systems, and additional time may facilitate decoding. For high data rate modes, the receiver may need additional time to decode the last OFDM(A) data symbol. In embodiments of the disclosure, the duration of the signal extension (SE) and the payload size in the last data symbol may be indicated to the receiver.

The last long OFDM symbol may comprise multiple fields. For example, Bit stream of the last (long) OFDM symbol (non-STBC) 520 may comprise an excess information bits field (e.g., Excess Info Bits 501, 506, 511, and/or 516) corresponding to additional encoded bits in the last long OFDM symbol. The additional encoded bits may correspond to source data (e.g., video stream, audio stream) sent between an access point (e.g., AP 102) and user devices (e.g., User Device(s) 120). Additional encoded bits may correspond to bits in the last long OFDM symbol that exceed a predetermined number of encoded bits that may be contained in the last long OFDM symbol that may be decoded by a recipient of a frame containing the last long OFDM symbol within a predetermined time. The excess information bits field may vary in size depending on the number of additional encoded bits included in Bit stream of the last (long) OFDM symbol (non-STBC) 520. Accordingly, as the size of the excess information bits field varies the signal extension field may also vary in size. As the excess information bits field increases the signal extension field may also increase because additional bits are being transmitted from thereby requiring a receiving processor to spend additional time processing the additional bits. For example, Excess Info Bits 506 may comprise more encoded bits than Excess Info Bits 501, and SE2 510 may comprise more unencoded bits, corresponding to a longer signal extension period that may be used by the receiving processor to decode bits in Excess Info Bits 501, than SE1 505. Excess Info Bits 511 may be greater in size than Excess Info Bits 506 and Excess Info Bits 501 and SE3 515 may be greater in size than SE2 510 and SE1 505. Excess Info Bits 516 may be greater than Excess Info Bits 511 and SE4 519 may be greater than SE3 515.

Bit stream of the last (long) OFDM symbol (non-STBC) 520 may also comprise one or more fields comprising unencoded non-informative bits (i.e., padding bits) prior to a Forward Error Correction field. The one or more fields may include a Fast Fourier Transform (FFT) field (not shown) followed by an Equalizer (EQ) field (not shown). In some embodiments, these fields may be referred to as pre-FEC padding bit fields (e.g., Pre-FEC Padding Bits 502, 507, 512, and/or 517). A receiving processor of Bit stream of the last (long) OFDM symbol (non-STBC) 520 may terminate decoding (e.g., Receiver decoding stops here 503, Receiver decoding stops here 508, Receiver decoding stops here 513, and/or Receiver decoding stops here 518) of Bit stream of the last (long) OFDM symbol (non-STBC) 520 after the corresponding pre-FEC padding bits fields (e.g., Pre-FEC Padding Bits 502, 507, 512, and/or 517) are decoded.

Bit stream of the last (long) OFDM symbol (non-STBC) 520 may also comprise one or more fields comprising unencoded non-informative bits (i.e., padding bits) after the FEC field. The one or more fields may include a Medium Access Control (MAC) field (not shown) followed by a Transmission (Tx) field (not shown) prior to sending a response to the transmitting processor that it received Bit stream of the last (long) OFDM symbol (non-STBC) 520 from. In some embodiments, these fields may be referred to as a post-FEC padding bits fields (e.g., Post-FEC Padding Bits 504, 509, and/or 514). Post-FEC Padding Bits 504 may be greater than Post-FEC Padding Bits 509, which may be greater than Post-FEC Padding Bits 514. In some embodiments Bit stream of the last (long) OFDM symbol (non-STBC) 520 may not comprise a post-FEC padding bits field. For example if the number of excess information bits exceeds a predetermined threshold (e.g., Excess Info Bits 516) a post-FEC padding bits field may not be included in Bit stream of the last (long) OFDM symbol (non-STBC) 520.

When the coded bit size in the last OFDM symbol exceeds a predetermined threshold for a given modulation, then Short Interframe Space (SIFS) may be unable to accommodate the processing time. In embodiments of the disclosure, a signal extension (SE) may effectively extend SIFS and provide more processing time, for example, as shown in FIG. 6.

In some embodiments SIFS 608 and 618 may be less than or equal to 16 microseconds. SIFS may correspond to the amount of time a receiving processor of Bit stream of the last (long) OFDM symbol (non-STBC) 520 may be allowed to decode the fields in Bit stream of the last (long) OFDM symbol (non-STBC) 520 before sending a response to the transmitting processor that it received Bit stream of the last (long) OFDM symbol (non-STBC) 520 from. For example, Coded Bits 601 may correspond to the number of coded bits less than a predetermined threshold (e.g., threshold 620) and bits 602 may correspond to bits that may be used to carry excess information bits when the number of coded bits exceeds the predetermined threshold. FFT 603 and EQ 604, may correspond to Pre-FEC Padding Bits, FEC 605 may correspond to one or more FEC that may be used to correct any errors that may have corrupted the coded bits, and MAC 606 and Tx 607 may correspond to Post-FEC Padding Bits. The receiving processor of a last long OFDM symbol, in which the number of coded bits do not exceed the threshold, may contain Pre-FEC Padding Bits, FEC 605, and Post-FEC Padding Bits all of which may be decoded in SIFS 608. After Pre-FEC Padding Bits, FEC 605, and Post-FEC Padding Bits are decoded before a response (e.g., Response 609) may be sent from the receiving processor to the transmitting processor. If the number of coded bits (e.g., Coded Bits 610) exceeds threshold 620 a SE (e.g., SE 612) may be added to the end of the last long OFDM symbol (e.g., Coded Bits 610 and bits 611) to delay the beginning of the SIFS (e.g., SIFS 618). The FEC field (e.g., FEC 615) may increase in size as the number of Coded Bits (e.g., Coded Bits 61) increases. FFT 613, EQ 614 and MAC 616, Tx 617 may correspond to Pre-FEC Padding bits and Post-FEC Padding Bits respectively. Response 619 may correspond to a response that the receiving processor may transmit to the transmitting processor after SIFS 618.

Embodiments of the disclosure may provide indications of device-specific, and in some instances user-specific, signal extension durations using a service field in a data payload, where a number of bits, such as 8 bits, may be available. Certain embodiments of the disclosure carry signal extension indications at various locations, such as HE-SIG-A for single user mode and HE-SIG-B for multiuser mode, and use the service field in the data payload, where 8 bits are available to indicate the signal extension to the receiver.

The systems, methods, and apparatuses of the disclosure may provide a signal extension duration for each user in a multiuser burst, rather than for a “worst user” scenario. By generating and/or determining a per-user or device-specific signal extension indication, signaling overhead may be reduced by using existing service fields to indicate signal extensions, as described herein.

Embodiments of the disclosure may be directed to per-user signal extension. For example, 3 or more SE bits may be used in HE-SIG-B for the whole PPDU. A first bit may indicate whether there is a SE in the PPDU, and the other two bits, or a second bit and a third bit, may indicate the SE duration. Because there may be multiple users' frames within one PPDU for multiuser modes such as OFDMA and MU-MIMO, each receiving user may want to know or otherwise desire whether its subchannel or streams have an SE appended. Embodiments of the disclosure therefore add per-user SE signaling. As a result, the signal extension is explicitly signaled and it is easy for the recipient or receiver to determine how much post-FEC padding and SE is present.

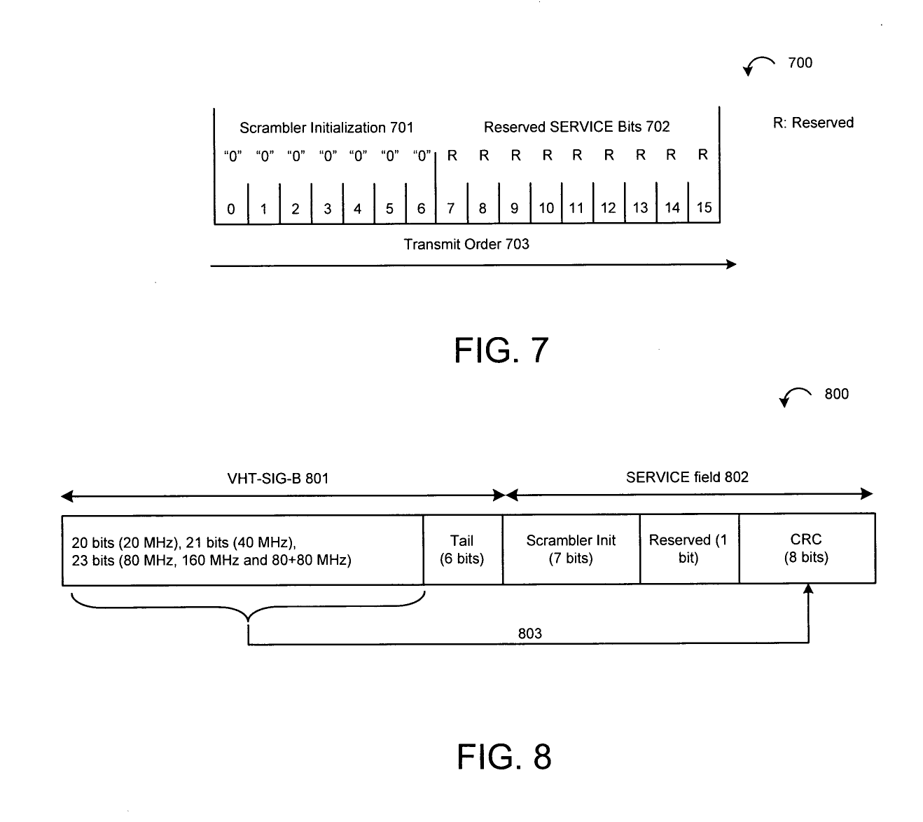

Referring to FIGS. 7 and 8, embodiments of the disclosure may reuse service fields. Because an intended receiver may need to know a per-user SE for its data, embodiments of the disclosure may use the service field (e.g., Service Field 700) to indicate that a SE field will be transmitted with the last long OFDM signal. A transmitting processor may transmit the bits in Service Field 700 in from left to right corresponding to Transmit Order 703. The first seven in Transmit Order 703 may correspond to Scrambler Initialization 701. Scrambler Initialization 701 may correspond to bits that may be used to initialize the state of feedback shift register. The feedback shift register may be additive or multiplicative. Reserved SERVICE Bits 702 may correspond to the last nine bits of Service Field 700 and may be used to indicate the presence of a SE in the payload of a PPDU.

In an IEEE 802.11ac system the service field may be used to indicate a channel that the transmitting processor may use to send a PPDU. For example a Very High Throughput-Signal-B (VHT-SIG-B) field (e.g., VHT-SIG-B 801) as shown in FIG. 8, may be used to indicate which channels the transmitting processor may transmit the PPDU on. The VHT-SIG-B field may also indicate (e.g., Indicator 803) where a cyclic redundancy check (CRC) may be located relative to the VHT-SIG-B field. VHT-SIG-B 801 may be followed by a 6 bits corresponding to the tail (e.g., Tail) of VHT-SIG-B 801. SERVICE field 802 may correspond to Service Field 700. Scrambler Init may be a field comprising 7 bits, Reserved may be a bit field comprising 1 bit, and CRC may comprise 8 bits. Scrambler Init may correspond to Scrambler Initialization 701 and Reserved and CRC may correspond to Reserved SERVICE Bits 702. In 11ax, HE-SIG-B CRCs may be in the HE-SIG-B field. Therefore, embodiments of the disclosure may use 2 or 3 or more bits to indicate the amount of post FEC padding and SE present. Alternatively, or in addition, embodiments of the disclosure may signal the amount of data or number of LDPC codewords present in the last symbol.

Embodiments of the disclosure may be configured to facilitate any amount of complexity in how the post-FEC padding and/or SE is added. The recipient or receiver may determine how much MAC data is present in the payload (when to terminate decoding). For example, the recipient could signal per MCS per BW per NSS thresholds during a capability exchange. The transmitter would then apply these rules at transmit time and signal the resulting post-FEC padding and SE added. In the MU scenario, when there is more padding than necessary (because of SE for another user), this could also be signaled. No computation may be needed at or by the recipient to determine when to terminate decoding.

Certain embodiments of the disclosure may have one or more signal extension options, such as 8 μs, instead of multiple options, such as the four options shown in FIG. 5. In another example, a 4 μs SE option may provide <10% efficiency gain. 11ax packet may be long and the shortest 11ax packet (1 payload symbol) is still longer than 50 μs. On the other hand, a 16 μs SE option may be used, or the transmitter may use additional MAC padding to provide additional processing time for the receiver. In such instances, additional signaling for 16 μs SE may not be needed, but additional capability threshold may be required for the transmitter to add the MAC padding.

Packets of the present disclosure may be self-defining. For example, third party STAs can demodulate packet without knowledge of device capability. The presence or absence of SE is signaled in L-SIG or HE-SIG-A or HE-SIG-B, applied to the PPDU (not per user). The number of coded bits in the last symbol is signaled in the service field applied to each user.

Example embodiments may provide SE granularity in signaling the number of coded bits or bytes in the last symbol. In some embodiments, the MAC may pad to the required granularity. In some embodiments, granularity may be a number of bits (e.g., 32 or 64 bits, etc.), while in other embodiments, granularity may be a fraction of symbol capacity (e.g., ¼, ½, ¾, 1/1, etc.).

Processing time may be determined by or based at least in part on the number of coded bits in the last symbol, modulation type, number of spatial streams, and the coding type. The number of codebits may determine the decoding latency; the modulation type may determine the demodulation latency; the number of streams may determine the spatial decoupling latency; and the coding type i.e. BCC or LDPC may affect decoding latency. FFT processing time may also contribute to the overall processing time. FFT processing time may be constant. In contrast, LDPC processing time may increase with the number of coded bits.

Because different receiver devices can have different processing time for the same data, the receiver device may communicate to the transmitter about the processing time such that the transmitter can add the SE if needed. In certain embodiments, the recipient device may provide the threshold for the coded bit size in the last data symbol. A threshold may be used for each modulation (BPSK, QPSK, 16QAM, 64QAM, 256QAM and 1024QAM), the allocated bandwidth, and the number of spatial streams. The granularity of the threshold may be in number of bits or bytes (e.g. 32 or 64 bits) or fraction of symbol capacity (e.g. ¼, ½, ¾ and full). The transmitter then applies the thresholds at transmit time to determine whether or not SE is needed. If SE is needed for one user, it may be applied to PPDU and seen by all users.

For downlink multiuser MIMO (DL MU-MIMO), the AP scheduler may determine how much data to send for each user. With a simple scheduling heuristic, the AP would form A-MPDUs for each user. If the coded bits in the last symbol exceed the SE threshold for any user, then SE is added to the PPDU. With a more complex scheduling heuristic, the AP iteratively builds the A-MPDUs for each user and ensures that the number of coded bits for each user is below each user's threshold in the last symbol.

For uplink MU-MMO PPDU, SE may not needed. The number of payload symbols is determined by the AP and signaled in the Trigger frame. Based on the MCS, the STA knows how much data can be sent in the last symbol without exceeding the threshold AP's SE threshold. The STA forms an A-MPDU that will not exceed the SE threshold in the last symbol. The number of coded bits in the last symbol is signaled in the service field.

Embodiments of the disclosure may signal extension by MAC padding. In one example, the required processing time may be longer than 8 μs SE. For example, the A-MPDU is formed and the last symbol exceeds the “extra 16 μs needed” threshold in coded bits. The MAC adds additional padding to fill the remainder of the symbol. An extra symbol is transmitted and the “number of coded bits in last symbol” is set to 0. Since there is no SE as such, it is just an extra symbol with no data.

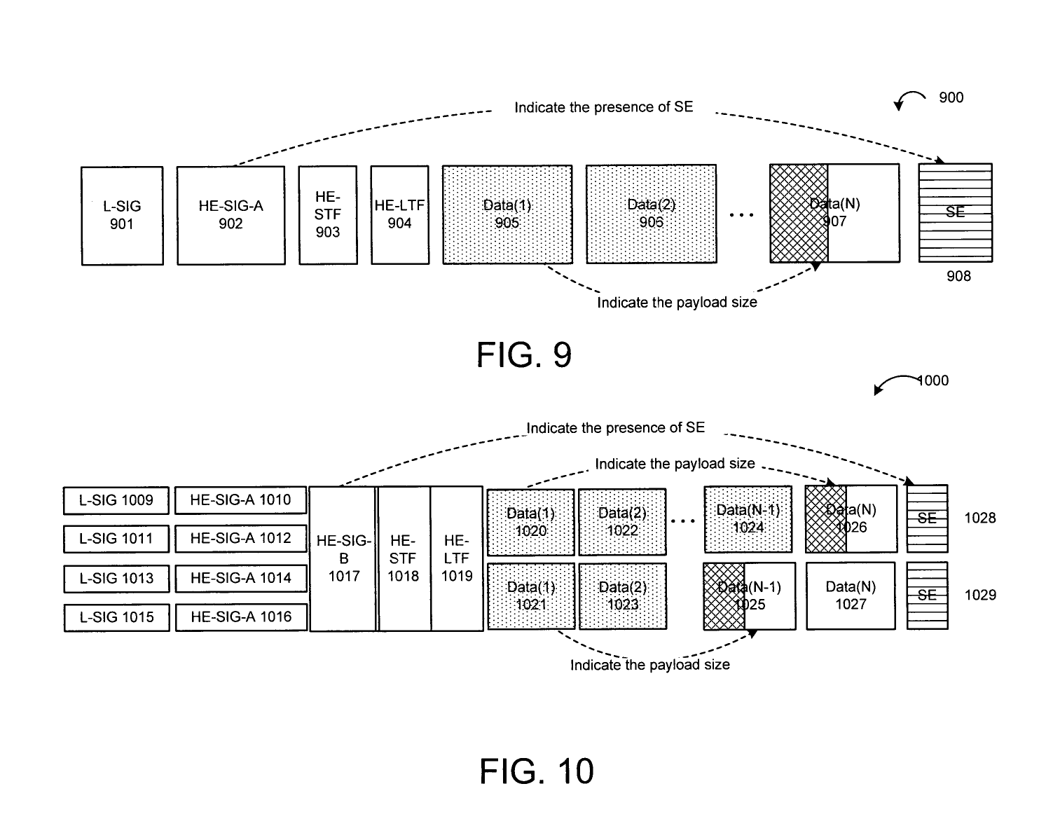

Referring to FIG. 9, for single user (SU) mode, a PPDU (e.g., PPDU 900) may be transmitted by a transmitting processor and may include a plurality of fields. For example, PPDU 900 may be comprised of a Legacy-Signal field (L-SIG 901), a High Efficiency-Signal-A field (HE-SIG-A 902), a High Efficiency-Short Training Field (HE-STF 903), High Efficiency-Long Training Field (e.g., HE-LTF 904), and a plurality of data symbols (e.g., Data(1) 905-Data(N) 907) and a service subfield in HE-SIG-A 902 may indicate the presence of a SE in a SE field (e.g., SE 908). A subfield in a first data field in the PPDU (e.g., Data(1) 905) may indicate the payload size (i.e., number of bits and therefore the number of data symbols in the PPDU). HE-SIG-A 902 may contain a CRC. In the example of FIG. 9, PPDU 900 may be transmitted using a 40 MHz channel equally divided into two 20 MHz subchannels. The SE is added after the last data symbol. If the recipient needs more processing time, the padding data symbol may be added after the last data symbol with MAC data. These padding data symbols don't carry MAC data.

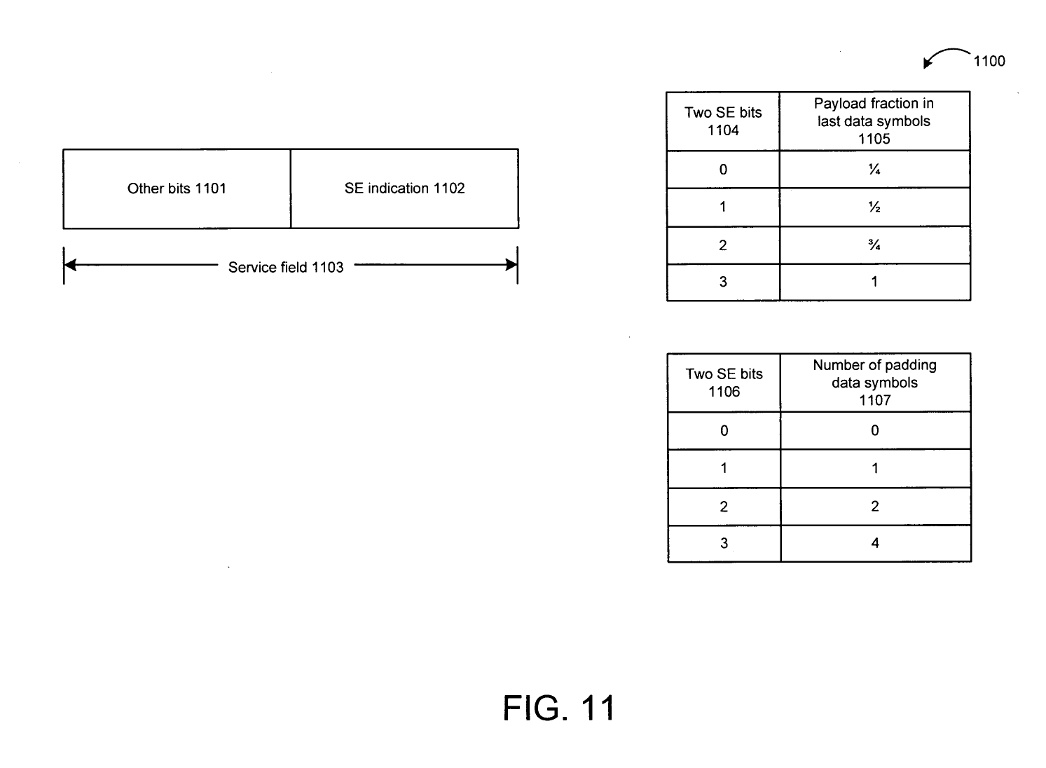

In another example illustrated in FIG. 10, for multiuser (MU) mode, there may be a HE-SIG-B field (e.g., HE-SIG-B 1017). Some user may need fewer data symbols than the others. Padding data symbol(s) may be added after the last data symbol with useful MAC data. The number of padding symbols may be indicated using service bits as illustrated in FIG. 11. The duration of each padding symbol may be 4 microseconds.

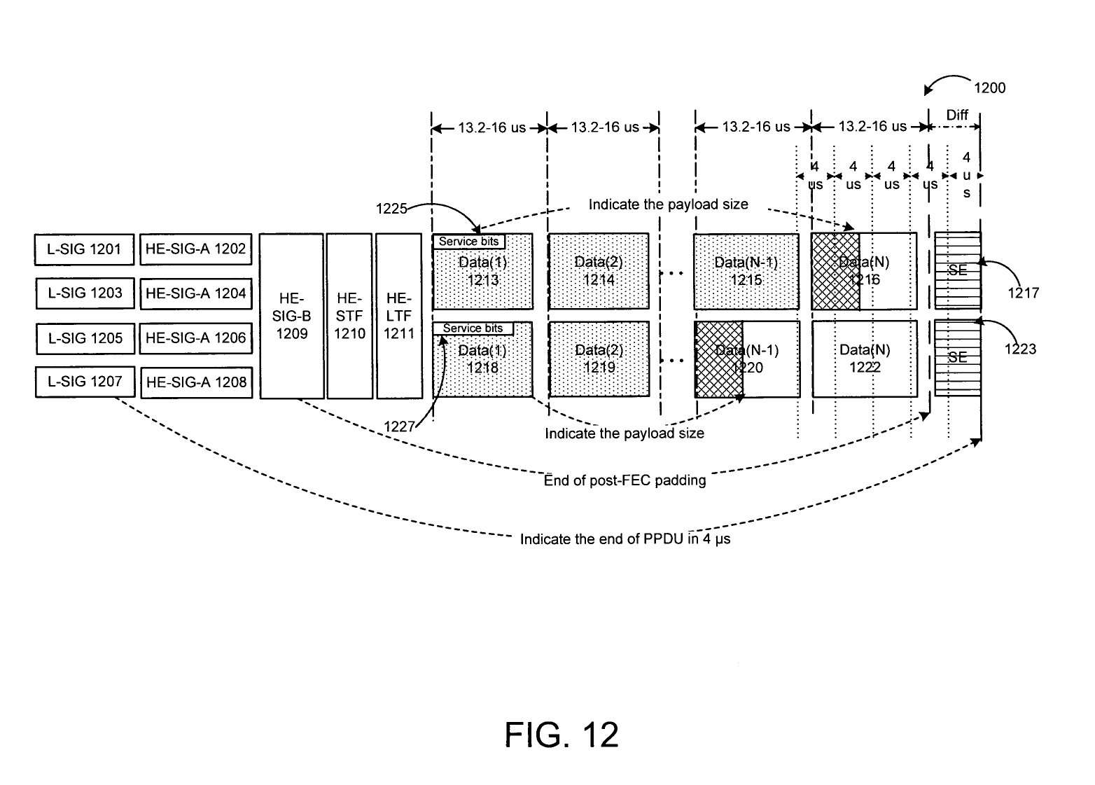

Embodiments of the disclosure may reuse a legacy length field. With reference to FIG. 12, embodiments of the disclosure may use the length field in a legacy signal field (L-SIG) (e.g., L-SIG 1009, 1011, 1013, and/or 1015) or repeated L-SIG (R-L-SIG) (not shown) alone or jointly with additional bits in HE-SIG-A or HE-SIG-B to indicate the presence and duration of SE. Because the legacy signal field (L-SIG) may be present in every PPDU, the length field in L-SIG may indicate the length of the PPDU in the unit of 4 microseconds using modulation and coding scheme 0 (i.e., MCS0). In PPDU 1000 HE-SIG-A 1010, 1012, 1014, and 1016 may correspond to HE-SIG-A 902. High Efficiency-Signal-B 1017 may be a high efficiency signal field corresponding to signals used to transmit the PPDU using IEEE 802.11 ax signal B. HE-STF 1018 may correspond to HE-STF 903 and HE-LTF 1019 may correspond to HE-LTF 904. Data(1) 1020-Data(N) 1026 may correspond to Data(1) 905-Data(N) 907. Similarly Data(1) 1021-Data(N) 1027 may correspond to Data(1) 905-Data(N) 907. SE 1028 and SE 1029 may correspond to SE 908. The length subfield in the L-SIG field may be reused to indicate the duration of SE as shown in FIG. 12.

Service field 1103 may further illustrate the service field. Service field 1103 may comprise two fields (i.e., Other bits 1101 and SE Indication 1102). Other bits 1101 may comprise bits corresponding to reserved bits and SE Indication 1102 may correspond to bits that may be used to indicate the presence of a SE in the PPDU. SE Indication 1102 may comprise two bits (e.g., Two SE bits 1104 and/or Two SE bits 1106) indicating the lengths of standard SE. For example, when Two SE Bits 1104 and 1106 are equal to 0, 1, 2, and 3 the duration of the SE may correspond to s 4, 8, 12, and 16 microsecond SE. Payload fraction in last data symbols 1105 may indicate the capacity of the last long OFDM symbol occupied by encoded data. Number of padding data symbols 1107 may correspond to the number of encoded data symbols that may be used to pad the last long OFDM symbol.

PPDU 1200 may be comprised of the same fields as PPDU 1000. L-SIG 1201-1207 may correspond to L-SIG 1009-1015, HE-SIG-A 1202-1208 may correspond to HE-SIG-A 1010-1016, HE-SIG-B 1209 may correspond to HE-SIG-B 1017, HE-STF 1210 may correspond to HE-STF 1018, HE-LTF 1211 may correspond to HE-LTF 1019, Data(1) 1213-Data(N) 1216 may correspond to Data(1) 1020-Data(N) 1026, Data(1) 1218-Data(N) 1222 may correspond to Data(1) 1021-Data(N) 1027, and SEs 1217 and 1223 may correspond to SEs 1028 and 1029 respectively. Service bits 1225 and 1227 may indicate the payload size in Data(N) 1216 and Data(N−1) 1220 respectively. A length field (not shown) in L-SIG 1207 may indicate when SE 1223 may terminate, and a field in HE-SIG-B 1209 may indicate when a receiving processor should finish decoding the post-FEC padding. If a SE is present, the length field in L-SIG may indicate the least length in 4 μs that covers the termination of SE as shown in FIG. 12. If a SE is not present, the length field may indicate the least length that covers the last MAC data symbol. The last MAC data symbol may be fully or partially filled with MAC data. The MAC data may be useful data or padding MAC data. Since the data symbol has duration from 13.2 to 16 μs depending on the guard interval (GI) used e.g. 0.4, or 0.8, or 1.6, or 3.2 μs, the granularity of the data symbol duration is about four times of that of the L-SIG length field. Therefore, 4 μs SE granularity as well as 8 μs may be supported. The exact termination time of the last data symbol or the end of post-FEC padding can be computed using the parameters i.e. GI duration, HE-LTF symbol duration, number of LTF symbols, number of HE-SIG-B symbols, HE-SIG-A repetition indication. These parameters are signaled in L-SIG or repeated L-SIG (R-L-SIG), HE-SIG-A, and HE-SIG-B. In some modes e.g. SU and triggered uplink PPDU, HE-SIG-B may not be present and the parameters are carried by the other fields.

The difference between the exact termination time of the last data symbol (shown as the solid line in FIG. 12) and the PPDU termination time specified in L-SIG length field (in 4 is) (shown as the other solid line in FIG. 12) indicates the duration of the added SE. For example, SE has a granularity of 4 μs. If the difference is less than 4 its, no SE is added. If the difference is equal to or greater than 4 its but less than 8 μs, then 4 μs SE is added. If the difference is equal to or greater than 8 μs but less than 12 μs, then 8 μs SE is added. If the difference is equal to or greater than 12 μs but less than 16 μs, then 12 μs SE is added. For another example, SE has a granularity of 8 μs. If the difference is less than 8 μs, no SE is added. If the difference is equal to or greater than 8 μs, then 8 μs SE is added. For adding a longer SE in both examples, one or more data symbols only with padding can be added. The service bits can be reused to indicate the payload size in the last data symbol with MAC data. In addition, the service bits can be reused to indicate the number of padding data symbols after the last data symbol with MAC data. MAC padding can be added in the MAC data. If there is a one-to-one mapping between the payload size in the last data symbol with MAC data and the SE duration, the service bits don't need to indicate the payload size since the SE duration can be computed from the difference between the exact termination time of the last data symbol and the PPDU termination time in L-SIG length field (in 4 μs).

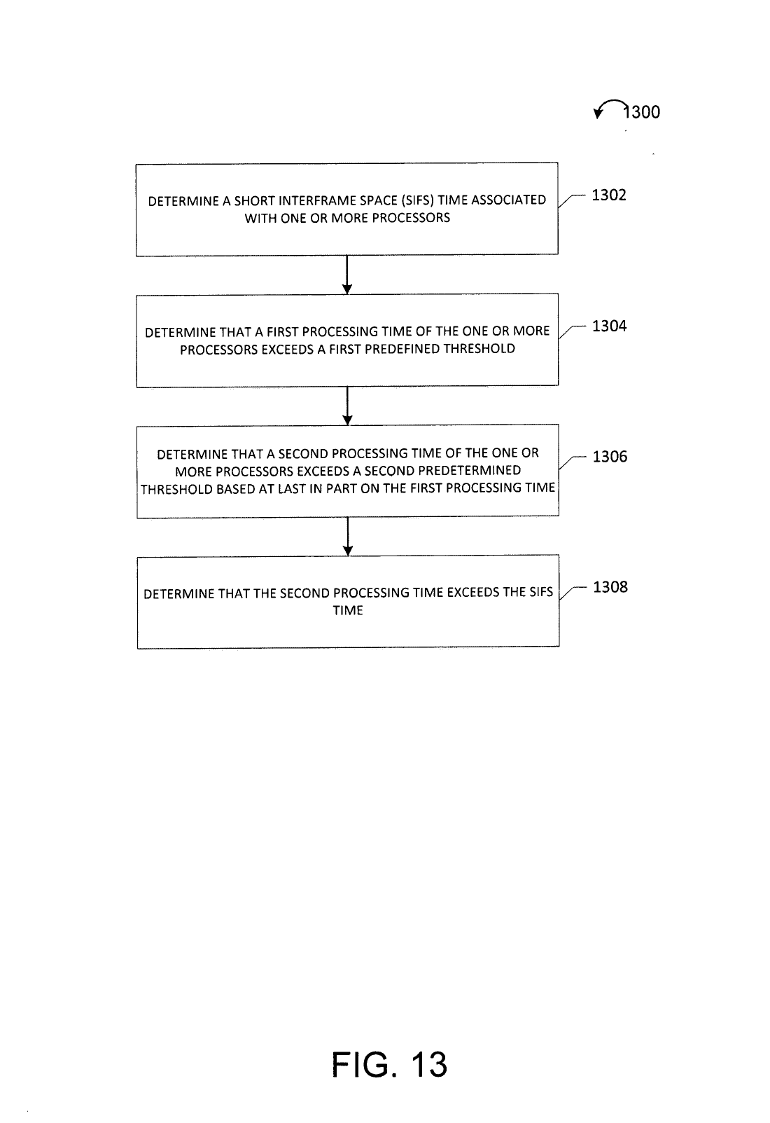

FIG. 13 depicts an illustrative process flow for determining the processing time of a packet, according to one or more example embodiments of the disclosure. At block 1302 one or more processors on user device may determine a short interframe space (SIFS) time associated with the one or more processors, and may determine that a first processing time of the one or more processors exceeds a predefined threshold associated with decoding a last symbol in a packet (block 1304). In block 1306 the one or more processors may determine that a second processing time of the one or more processor exceeds a second predetermined threshold based at least in part on the first processing time. After determining the second processing time, of the one or more processors, the one or more processors may determine that the second processing time exceeds the SIFS time.

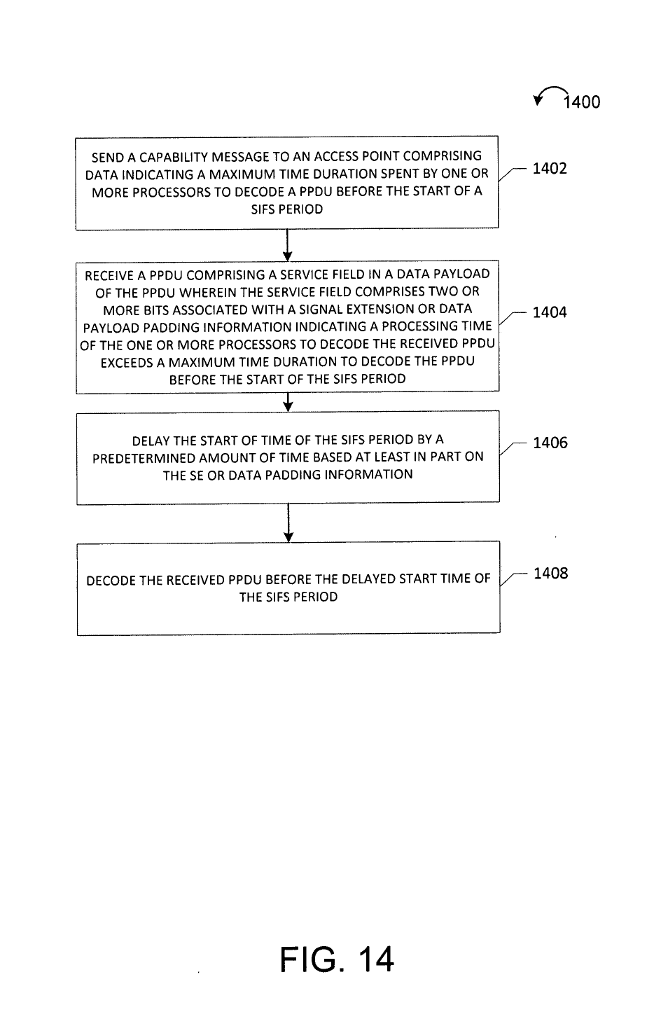

FIG. 14 depicts an illustrative process flow for determining the processing time of a packet, according to one or more example embodiments of the disclosure. At block 1402 one or more processors of a user device may send a capability message to an access point comprising data indicating a maximum time duration that may be spent by the one or more processors to decode a PPDU before the start of a SIFS period. At block 1404 the one or more processors may receive a PPDU comprising a service field in a data payload of the PPDU. The service field may comprise two or more bits associated with a SE or data payload padding information indicating a processing time of the one or more processors to decode the received PPDU exceeds maximum time duration to decode the PPDU before the start of the SIFS period. The one or more processors may delay the start time of the SIFS period by a predetermined amount of time based at least in part on the SE or data padding information (block 1406). After delaying the start time of SIFS the one or more processors may decode the received PPDU before the delayed start time of the SIFS period (block 1408).

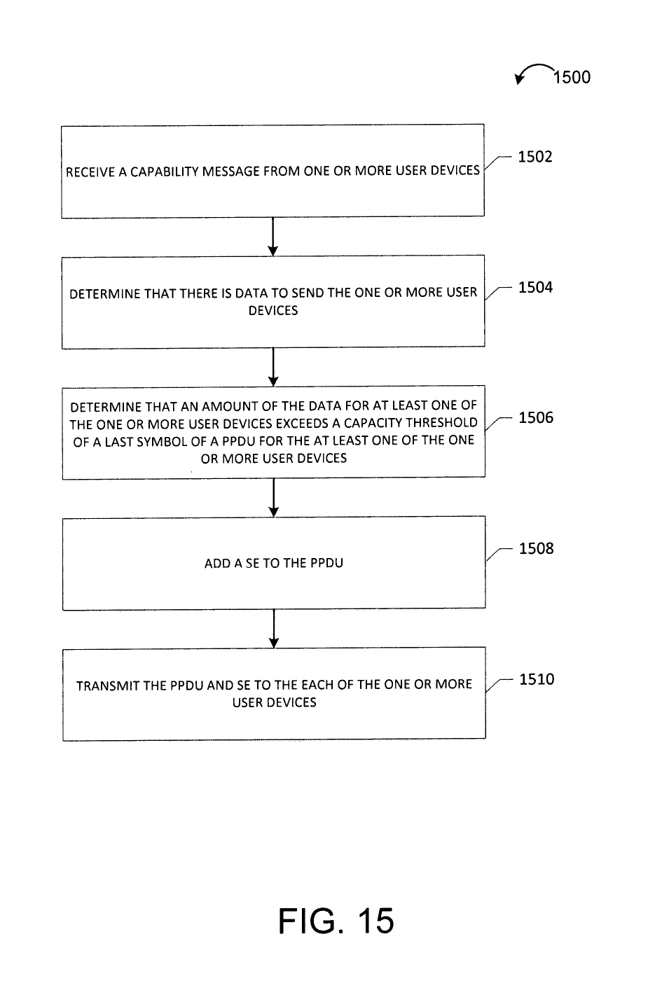

FIG. 15 depicts an illustrative process flow for transmitting a downlink frame with a signal extension, according to one or more example embodiments of the disclosure. At block 1502 one or more processors in an access point (AP), may receive a capability message from one or more user devices. The one or more processors may determine that there is data to send to the one or more user devices (block 1504). At block 1506, the one or more processors may determine that an amount of the data for at least one of the one or more user devices exceeds a capacity, threshold of a last symbol of a PPDU for the at least one of the one or more user devices. At block 1508 the one or more processors may add a SE to the PPDU, and transmit both to each of the one or more user devices (block 510).

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Certain embodiments may be implemented in one or a combination of hardware, firmware and software. Other embodiments may also be implemented as instructions stored on a computer-readable storage device, which may be read and executed by at least one processor to perform the operations described herein. The instructions may be in any suitable form, such as but not limited to source code, compiled code, interpreted code, executable code, static code, dynamic code, and the like. A computer-readable storage device or medium may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

In example embodiments of the disclosure, there may be a wireless communication device, comprising: at least one memory storing computer-executable instructions; and at least one processor configured to access the at least one memory, wherein the at least one processor is configured to execute the computer-executable instructions to: determine a short interframe space (SIFS) time associated with the at least one processor; determine that a first processing time of the at least one processor exceeds a first predefined threshold, wherein the first processing time corresponds to a time spent processing a symbol in a protocol data unit (PDU) exceeding a predetermined coded bit size threshold; determine that a second processing time of the at least one processor exceeds a second predetermined threshold, based at least in part on the first processing time; determine that the second processing time exceeds the SIFS time; and set a length field value in a subfield of a Legacy Signal (L-SIG) field and a subfield of Repeated Legacy Signal (RL-SIG) field of the PDU based at least in part on the first and second processing time.

Implementations may include one or more of the following features. The wireless communication device may further comprise at least one transceiver. The wireless communication device may further comprise at least one antenna electrically coupled to each of the at least one transceivers. The second processing time of the wireless communication device may be based at least in part on a time spent by the at least one processor processing a Fast Fourier Transform (FFT), Equalization (EQ), Forward Error Correction (FEC), Medium Access Control (MAC), and Transmission (Tx) field in the PDU. The threshold associated with the FEC may be based at least in part on the predetermined coded bit size threshold. The time spent by the at least one processor processing the FFT, EQ, FEC, MAC, and Tx fields may exceed sixteen microseconds. The at least one processor may be further configured to send a capability exchange message based at least in part on the second processing time exceeding the SIFS time. The capability exchange message may comprise a processing time threshold associated with a modulation and coding scheme, an allocated bandwidth, and a number of spatial streams. The PDU may be a physical layer convergence procedure PDU (PPDU). The first predefined threshold may comprise an integer number of octets. The integer may be 4 or 8. The first predefined threshold may be a fraction of the capacity of the symbol. The capacity of the symbol may be one-fourth, one-half, or three-fourths the capacity of the symbol. The first predefined threshold may be equivalent to the capacity of the symbol. The length field value in L-SIG and RL-SIG may correspond to the least length covering the termination of a last High Efficiency (HE) OFDM symbol without a signal extension (SE) or the termination of the last HE OFDM symbol with a SE. The least length may be 4 microseconds that covers the termination of the last HE OFDM symbol with the SE. The last HE OFDM symbol may correspond to a last MAC data symbol.

In example embodiments of the disclosure, there may be a wireless communication device, comprising: at least one memory storing computer-executable instructions; and at least one processor configured to access the at least one memory, wherein the at least one processor is configured to execute the computer-executable instructions to: send a capability message to an access point comprising data indicating a maximum time duration spent by the at least one processor to decode a PPDU before the start time of a SIFS period; receive a PPDU comprising a service field in a data payload of the PPDU, wherein the service field comprises two or more first bits associated with a Signal Extension (SE) or data payload padding information indicating that a processing time of the at least one processor to decode the received PPDU exceeds the maximum time duration to decode a PPDU before the start time of the SIFS period; delay the start time of the SIFS period of the at least one processor by a predetermined amount of time based at least in part on the SE or data padding information; and decode the received PPDU before the delayed start time of the SIFS period.

Implementations may include one or more of the following features. The wireless communication device may further comprise at least one transceiver. The wireless communication device may further comprise at least one antenna electrically coupled to each of the at least one transceivers. The PPDU may further comprise a Legacy Signal (L-SIG) field, High Efficiency Short Training Field (HE-STF), High Efficiency Long Training Field (HE-LTF), High Efficiency Signal A (HE-SIG-A), and at least one symbol in the data payload in Single User (SU) mode. The PPDU may further comprise a Legacy Signal (L-SIG) field, High Efficiency Short Training Field (HE-STF), High Efficiency Long Training Field (HE-LTF), High Efficiency Signal A (HE-SIG-A), and at least one symbol in the data payload in Multiuser (MU) mode. The service field may further comprise two or more second bits indicating a number of coded bits in a last symbol of the data payload. The at least one processor may be further configured to execute the computer-executable instructions to: receive a trigger frame from an access point comprising at least one field indicating a maximum number of symbols in a data payload that can be received from the wireless communication device; determine that there is data to send to the access point; determine the maximum amount of data that can be sent to the access point in a last symbol of the data payload, based at least in part on a Modulation Coding Scheme (MCS), and the at least one field in the trigger frame; generate an Aggregated Medium Access Control PDU (A-MPDU) comprising the data to send to the access point such that the data does not exceed the maximum amount of data that can be sent in the last symbol of the data payload; encapsulate the A-MPDU in an uplink (UL) PPDU; and transmit the UL PPDU to the access point. The UL PPDU may further comprise a service field indicating a number of coded bits in the last symbol of the data payload.

In example embodiments of the disclosure, there may be a wireless communication device, comprising: at least one memory storing computer-executable instructions; and at least one processor configured to access the at least one memory, wherein the at least one processor is configured to execute the computer-executable instructions to: receive a capability exchange message from one or more user devices; determine that there is data to send to the one or more user devices; determine that an amount of the data, for at least one of the one or more user devices, exceeds a capacity threshold of a last symbol of a PPDU for the at least one of the one or more user devices; add a SE to the PPDU; and transmit the PPDU and SE to each of one or more user devices.

Implementations may include one or more of the following features. The wireless communication device may comprise at least one transceiver. The wireless communication device may comprise at least one antenna electrically coupled to each of the at least one transceivers.

In example embodiments of the disclosure, there may be a non-transitory computer readable medium including instructions stored thereon, which when executed by one or more processors of a communication device, cause the one or more processors to perform operations of: determining a short interframe space (SIFS) time associated with the at least one processor; determining that a first processing time of the at least one processor exceeds a first predefined threshold, wherein the first processing time correspond to a time spent processing a symbol in a protocol data unit (PDU) exceeding a predetermined coded bit size threshold; determining that a second processing time of the at least one processor exceeds a second predetermined threshold, based at least in part on the first processing time; and determining that the second processing time exceeds the SIFS time.

In example embodiments of the disclosure, there may be a method comprising: determining a short interframe space (SIFS) time associated with the at least one processor; determining that a first processing time of the at least one processor exceeds a first predefined threshold, wherein the first processing time correspond to a time spent processing a symbol in a protocol data unit (PDU) exceeding a predetermined coded bit size threshold; determining that a second processing time of the at least one processor exceeds a second predetermined threshold, based at least in part on the first processing time; and determining that the second processing time exceeds the SIFS time.

In example embodiments of the disclosure, there may be a wireless communication device, comprising: a means for determining a short interframe space (SIFS) time associated with the at least one processor; a means for determining that a first processing time of the at least one processor exceeds a first predefined threshold, wherein the first processing time corresponds to a time spent processing a symbol in a protocol data unit (PDU) exceeding a predetermined coded bit size threshold; a means for determining that a second processing time of the at least one processor exceeds a second predetermined threshold, based at least in part on the first processing time; a means for determining that the second processing time exceeds the SIFS time; and a means for setting a length field value in a subfield of a Legacy Signal (L-SIG) field and a subfield of Repeated Legacy Signal (RL-SIG) field of the PDU based at least in part on the first and second processing time.

In example embodiments of the disclosure, there may be a wireless communications device, comprising: a means for sending a capability message to an access point comprising data indicating a maximum time duration spent by the at least one processor to decode a PPDU before the start time of a SIFS period; a means for receiving a PPDU comprising a service field in a data payload of the PPDU, wherein the service field comprises two or more first bits associated with a Signal Extension (SE) or data payload padding information indicating that a processing time of the at least one processor to decode the received PPDU exceeds the maximum time duration to decode a PPDU before the start time of the SIFS period; a means for delaying the start time of the SIFS period of the at least one processor by a predetermined amount of time based at least in part on the SE or data padding information; and a means for decoding the received PPDU before the delayed start time of the SIFS period.

In example embodiments of the disclosure, there may be a wireless communications device, comprising: a means for receiving a capability exchange message from one or more user devices; a means for determining that there is data to send to the one or more user devices; a means for determining that an amount of the data, for at least one of the one or more user devices, exceeds a capacity threshold of a last symbol of a PPDU for the at least one of the one or more user devices; a means for adding a SE to the PPDU; and a means for transmitting the PPDU and SE to each of one or more user devices.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wireless communication device, comprising:
at least one memory storing computer-executable instructions; and
at least one processor configured to access the at least one memory, wherein the at least one processor is configured to execute the computer-executable instructions to:
determine a short interframe space (SIFS) time associated with the at least one processor;
determine that a first processing time of the at least one processor exceeds a first predefined threshold, wherein the first processing time corresponds to a time spent processing a symbol in a protocol data unit (PDU) exceeding a predetermined coded bit size threshold;
determine that a second processing time of the at least one processor exceeds a second predetermined threshold, based at least in part on the first processing time;
determine that the second processing time exceeds the SIFS time; and
set a length field value in a subfield of a Legacy Signal (L-SIG) field and a subfield of Repeated Legacy Signal (RL-SIG) field of the PDU based at least in part on the first and second processing time.

2. The wireless communication device of claim 1, further comprising at least one transceiver.

3. The wireless communication device of claim 2, further comprising at least one antenna electrically coupled to each of the at least one transceivers.

4. The wireless communication device of claim 1, wherein the second processing time is based at least in part on a time spent by the at least one processor processing a Fast Fourier Transform (FFT), Equalization (EQ), Forward Error Correction (FEC), Medium Access Control (MAC), and Transmission (Tx) field in the PDU.

5. The wireless communication device of claim 4, wherein a threshold associated with the FEC is based at least in part on the predetermined coded bit size threshold.

6. The wireless communication device of claim 4, wherein the time spent processing the FFT, EQ, FEC, MAC, and Tx fields exceeds sixteen microseconds.

7. The wireless communication device of claim 1, wherein the at least one processor is further configured to execute the computer-executable instructions to:
send a capability exchange message based at least in part on the second processing time exceeding the SIFS time.

8. The wireless communication device of claim 7, wherein the capability exchange message comprises a processing time threshold associated with a modulation and coding scheme, an allocated bandwidth, and a number of spatial streams.

9. The wireless communication device of claim 1, wherein the PDU is a physical layer convergence procedure PDU (PPDU).

10. The wireless communication device of claim 1, wherein the first predefined threshold comprises an integer number of octets.

11. The wireless communication device of claim 10, wherein the integer is 4 or 8.

12. The wireless communication device of claim 1, wherein the first predefined threshold is a fraction of the capacity of the symbol.

13. The wireless communication device of claim 12, wherein the fraction of the capacity of the symbol is one-fourth, one-half, or three-fourths the capacity of the symbol.

14. The wireless communication device of claim 1, wherein the first predefined threshold is equivalent to the capacity of the symbol.

15. The wireless communication device of claim 1, wherein the length field value in L-SIG and RL-SIG corresponds to the least length covering the termination of a last High Efficiency (HE) OFDM symbol without a signal extension (SE) or the termination of the last HE OFDM symbol with a SE.

16. The wireless communication device of claim 15, wherein the least length is 4 microseconds that covers the termination of the last HE OFDM symbol with the SE.

17. The wireless communication device of claim 15, wherein the last HE OFDM symbol corresponds to a last MAC data symbol.

18. A wireless communication device comprising:
at least one memory storing computer-executable instructions; and
at least one processor configured to access the at least one memory, wherein the at least one processor is configured to execute the computer-executable instructions to:
send a capability message to an access point comprising data indicating a maximum time duration spent by the at least one processor to decode a PPDU before the start time of a SIFS period;
receive a PPDU comprising a service field in a data payload of the PPDU, wherein the service field comprises two or more first bits associated with a Signal Extension (SE) or data payload padding information indicating that a processing time of the at least one processor to decode the received PPDU exceeds the maximum time duration to decode a PPDU before the start time of the SIFS period;
delay the start time of the SIFS period of the at least one processor by a predetermined amount of time based at least in part on the SE or data padding information; and
decode the received PPDU before the delayed start time of the SIFS period.

19. The wireless communication device of claim 18, further comprising at least one transceiver.

20. The wireless communication device of claim 19, further comprising at least one antenna electrically coupled to each of the at least one transceivers.

21. The wireless communication device of claim 18, wherein the PPDU further comprises a Legacy Signal (L-SIG) field, High Efficiency Short Training Field (HE-STF), High Efficiency Long Training Field (HE-LTF), High Efficiency Signal A (HE-SIG-A), and at least one symbol in the data payload in Single User (SU) mode.

22. The wireless communication device of claim 18, wherein the PPDU further comprises a Legacy Signal (L-SIG) field, High Efficiency Short Training Field (HE-STF), High Efficiency Long Training Field (HE-LTF), High Efficiency Signal A (HE-SIG-A), and at least one symbol in the data payload in Multiuser (MU) mode.

23. The wireless communication device of claim 18, wherein the service field further comprises two or more second bits indicating a number of coded bits in a last symbol of the data payload.

24. The wireless communication device of claim 18, wherein the at least one processor is further configured to execute the computer-executable instructions to:
receive a trigger frame from an access point comprising at least one field indicating a maximum number of symbols in a data payload that can be received from the wireless communication device;
determine that there is data to send to the access point;
determine the maximum amount of data that can be sent to the access point in a last symbol of the data payload, based at least in part on a Modulation Coding Scheme (MCS), and the at least one field in the trigger frame;
generate an Aggregated Medium Access Control PDU (A-MPDU) comprising the data to send to the access point such that the data does not exceed the maximum amount of data that can be sent in the last symbol of the data payload;
encapsulate the A-MPDU in an uplink (UL) PPDU; and
transmit the UL PPDU to the access point.

25. The wireless communication device of claim 24, wherein the UL PPDU comprises a service field indicating a number of coded bits in the last symbol of the data payload.

26. A wireless communication device comprising:
at least one memory storing computer-executable instructions; and
at least one processor configured to access the at least one memory, wherein the at least one processor is configured to execute the computer-executable instructions to:
receive a capability exchange message from one or more user devices;
determine that there is data to send to the one or more user devices;
determine that an amount of the data, for at least one of the one or more user devices, exceeds a capacity threshold of a last symbol of a PPDU for the at least one of the one or more user devices;
add a SE to the PPDU; and
transmit the PPDU and SE to each of one or more user devices.

27. The wireless communication device of claim 26, further comprising at least one transceiver.

28. The wireless communication device of claim 27, further comprising at least one antenna electrically coupled to each of the at least one transceivers.

29. A non-transitory computer readable medium including instructions stored thereon, which when executed by one or more processors of a communication device, cause the one or more processors to perform operations of:
determining a short interframe space (SIFS) time associated with the at least one processor;
determining that a first processing time of the at least one processor exceeds a first predefined threshold, wherein the first processing time correspond to a time spent processing a symbol in a protocol data unit (PDU) exceeding a predetermined coded bit size threshold;
determining that a second processing time of the at least one processor exceeds a second predetermined threshold, based at least in part on the first processing time; and
determining that the second processing time exceeds the SIFS time.

30. A method comprising:
determining a short interframe space (SIFS) time associated with the at least one processor;
determining that a first processing time of the at least one processor exceeds a first predefined threshold, wherein the first processing time correspond to a time spent processing a symbol in a protocol data unit (PDU) exceeding a predetermined coded bit size threshold;
determining that a second processing time of the at least one processor exceeds a second predetermined threshold, based at least in part on the first processing time; and
determining that the second processing time exceeds the SIFS time.
